(19) United States
(12) Patent Application Publication
(10) Pub. No.: US 2026/0048741 A1
(43) Pub. Date: Feb. 19, 2026

(54) VEHICULAR CONTROL SYSTEM WITH ACCELERATION CONTROL FOR ADAPTIVE CRUISE CONTROL

(71) Applicant: Magna Electronics Inc., Auburn Hills, MI (US)

(72) Inventors: Arpit Awathe, Rochester Hills, MI (US); Tejas Murlidhar Varunjikar, Troy, MI (US)

(21) Appl. No.: 19/299,401

(22) Filed: Aug. 14, 2025

Related U.S. Application Data
(60) Provisional application No. 63/683,738, filed on Aug. 16, 2024.

(51) Int. Cl. B60W 30/16; B60W 50/02

(52) U.S. Cl. CPC B60W 30/16; B60W 50/0205; B60W 2520/10; B60W 2552/53; B60W 2554/802; B60W 2720/106

(57) ABSTRACT

A vehicular control system includes a sensor disposed at a vehicle and, based on processing of captured sensor data, determines a leading vehicle within a traffic lane the equipped vehicle is currently traveling along, and controls the equipped vehicle to travel at a following speed that approximates speed of the leading vehicle with at least an initial following distance between the equipped vehicle and the leading vehicle. The vehicular control system receives an updated following distance different from the initial following distance and determines a period of time based on the initial following distance, the updated following distance, and the following speed. The system determines a velocity profile based on the determined period of time and controls acceleration of the equipped vehicle based on the velocity profile to establish the updated following distance between the equipped vehicle and the leading vehicle.

### CROSS REFERENCE TO RELATED APPLICATION

The present application claims the filing benefits of U.S. provisional application Ser. No. 63/683,738, filed Aug. 16, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more cameras and/or radar sensors at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular sensing system or vehicular control system includes a sensor disposed at a vehicle equipped with the vehicular control system and senses at least forward of the vehicle and is operable to capture sensor data. The vehicular control system also includes an electronic control unit (ECU) that has electronic circuitry and associated software. Sensor data captured by the sensor is transferred to the ECU, which has a data processor for processing sensor data captured by the sensor. The vehicular control system, responsive to processing at the ECU of captured sensor data, determines a leading vehicle in front of the equipped vehicle and within a traffic lane the equipped vehicle is currently traveling along. Responsive to determining the leading vehicle, the vehicular control system controls the equipped vehicle to travel at a following speed that approximates the speed of the leading vehicle with at least an initial following distance between the equipped vehicle and the leading vehicle. While the equipped vehicle is traveling at the following speed with at least the initial distance between the equipped vehicle and the leading vehicle, the vehicular control system receives an updated following distance different from the initial following distance from a diver of the equipped vehicle. Responsive to receiving the updated distance from the driver of the equipped vehicle, the vehicular control system determines a period of time based on the initial following distance, the updated following distance, and the following speed. The period of time represents a duration of time during which the equipped vehicle transitions from the initial following distance to the updated following distance. The vehicular control system determines a velocity profile for the equipped vehicle to follow based on the determined period of time. The velocity profile is determined such that the equipped vehicle is following the leading vehicle at the updated following distance and at the following speed at an end of the period of time. The vehicular control system controls acceleration of the equipped vehicle based on the velocity profile to establish the updated following distance between the equipped vehicle and the leading vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular sensing system that incorporates sensors;

FIG. 2 is a schematic view of an adaptive cruise control algorithm;

FIG. 3 is a schematic view of an example scenario of an equipped vehicle following a target vehicle with a change in a gap setting;

FIG. 4 illustrates a velocity and distance trajectory profile generation with desired velocity selection; and

FIG. 5 is a schematic view of a longitudinal control module.

### DESCRIPTION OF THE PREFERRED EMBODIMENTS

A vehicle sensing system and/or driver or driving assist system operates to capture sensor data representative of the exterior of the vehicle and may process the captured sensor data to detect objects at or near the vehicle and in the area of the vehicle, such as to assist a driver of the vehicle in maneuvering the vehicle in a forward or rearward direction. The driving assist system includes a processor or processing system that is operable to process sensor data that is transferred to the processor from one or more sensors (e.g., radar sensors, lidar sensors, ultrasonic sensors, imaging sensors, etc.).

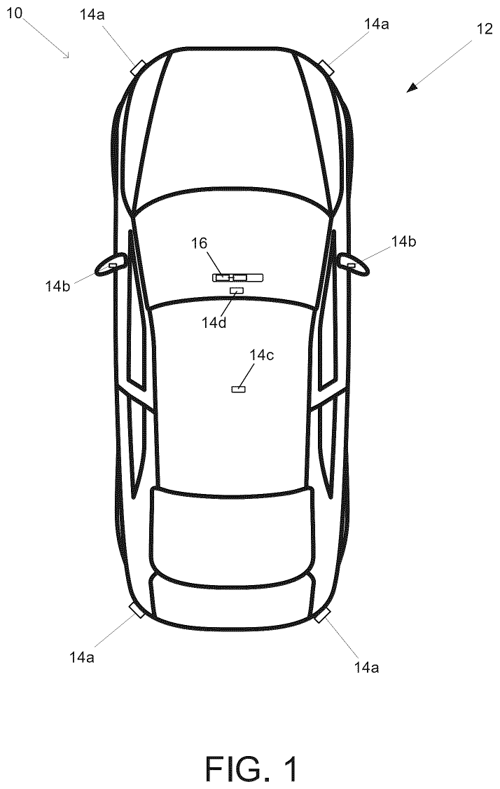

Referring now to the drawings and the illustrative embodiments depicted therein, a vehicle 10 (FIG. 1) includes a driving assistance system 12 that includes at least one exterior viewing sensor, such as one or more radar sensors 14a, sideward cameras 14b, lidar sensors 14c, forward-viewing cameras 14d, ultrasonic sensors, and/or any other imaging sensor. Each sensor 14a-d may be disposed at, for example, one or both exterior side mirrors of the vehicle, at one or more corners of the vehicle (e.g., at a corner of a bumper), at a windshield of the vehicle (e.g., the forward-viewing camera 14d may be disposed at an in-cabin side of the windshield and viewing forward of the vehicle through the windshield), and/or at a rooftop of the vehicle. The sensor(s) capture sensor data representative of the scene occurring exterior of the vehicle (e.g., at least forward, and/or rearward of the vehicle). The driving assistance system 12 includes a control or electronic control unit (ECU) 16 having electronic circuitry and associated software, with the electronic circuitry including a data processor or image processor that is operable to processor sensor data captured by the sensors, whereby the vehicular sensing system or ECU may detect or determine presence of objects or the like and alert an occupant of the vehicle and/or control movement of the vehicle. The data transfer or signal communication from the camera to the ECU may comprise any suitable data or communication link, such as a vehicle network bus or the like of the equipped vehicle.

Advanced driver assistance systems (ADAS) gather information about the surrounding environment through various sensors. This information is utilized by multiple features such as adaptive cruise control (ACC), lane centering, and lane keep assist to assist the driver while operating the vehicle. ACC specifically utilizes data from sensors like cameras, radar, ultrasonic sensors, and lidar, incorporating object and lane-marking information for longitudinal control.

The ACC feature primarily manages the vehicle's speed by maintaining a driver-selected speed. That is, the driver sets the desired speed, which the ACC then maintains. If there is an object (e.g., another vehicle) traveling in front of the equipped vehicle at a speed that is slower than the desired speed set by the driver, the ACC reduces the speed of the vehicle to match the leading vehicle while maintaining a user-selected gap or distance between the equipped vehicle and the leading vehicle. The user-selected gap defines the minimum safe following distance. For example, the user-selected gap may instruct the ACC feature to maintain a twenty-foot (or fifty-foot or more) distance between the equipped vehicle and another vehicle ahead of the equipped vehicle. Alternatively, the user-selected gap indicates the ACC should maintain a gap or distance equivalent to a period of time (e.g., 1 second, 2 seconds, 3 seconds, etc.). This period of time dictates how long it would take the equipped vehicle to reach the leading vehicle if the leading vehicle were to suddenly stop. The user-selected gap can be adjusted dynamically while the equipped vehicle follows the target vehicle. If the target vehicle stops, the ACC ensures that the equipped vehicle halts or stops at a specified distance referred to as the stopping distance, preventing a collision. Once the target vehicle resumes movement, the ACC may increase speed such that the equipped vehicle remains the set distance or time gap from the leading vehicle.

During transitions between different user-selected gap settings, the ACC ensures smooth operations and gently adjusts the distance between vehicles, minimizing abrupt changes in vehicle behavior. Additionally, the ACC reduces the vehicle's speed on curved roads to limit lateral acceleration, thereby enhancing vehicle stability and passenger comfort. The ACC calculates the necessary acceleration or deceleration based on maintaining the established gap or velocity, or ensuring the vehicle stops at a set distance from a stationary target vehicle. This calculated information may be relayed to a low-level controller, which adjusts the vehicle's speed by either applying the brakes to decrease the speed or providing torque to increase the speed. Implementations herein are directed towards a longitudinal vehicle control using information about objects and lanes in the vehicle's surroundings to follow a target object ahead while maintaining a desired gap from the target vehicle which is set by the driver of the vehicle.

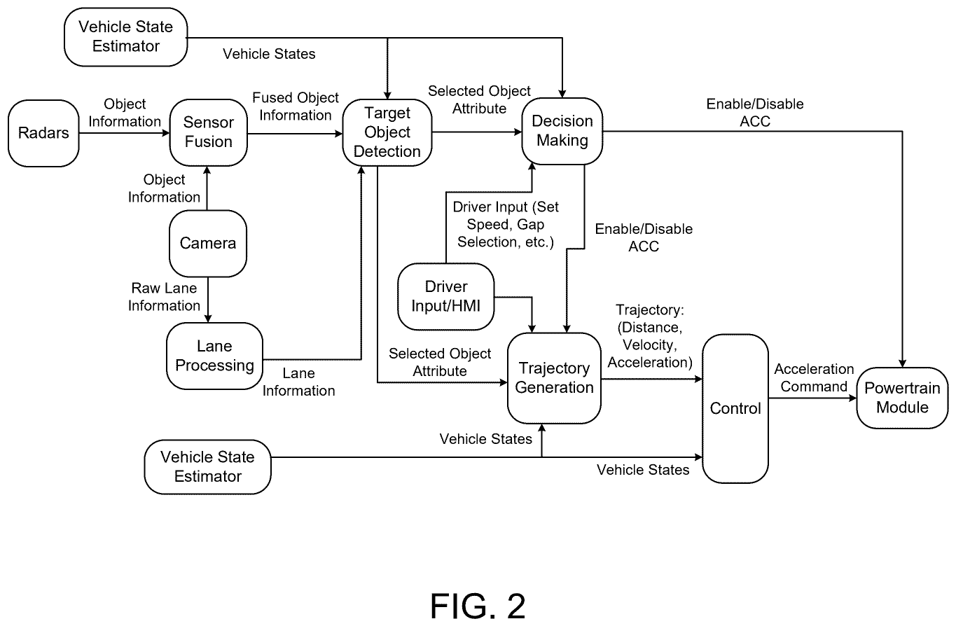

FIG. 2 illustrates an example ACC system. The ACC system may include one or more cameras where hardware and software of the camera transmits raw lane and front object data, including lane coefficients, quality, relative position of objects, velocity, acceleration, object type, etc. The ACC system may additionally or alternatively include one or more radar sensors where hardware and software of the radar sensor transmits raw object data, such as relative positions of objects, velocity, acceleration, object type, etc. The ACC system optionally uses sensor fusion to integrate object data from multiple sensors to accurately determine object position and various parameters, such as pose, velocity, acceleration, etc. For example, the system may include a forward-viewing camera and the system may process image data captured by the forward-viewing camera to determine lane markers of traffic lanes on the road along which the vehicle is traveling. The system may determine a leading vehicle on the road ahead of the equipped vehicle, such as via processing of image data captured by the forward-viewing camera and/or sensor data captured by a forward-sensing sensor (such as a forward-sensing radar sensor or forward-sensing lidar sensor or forward-sensing ultrasonic sensor). Based on the determined traffic lanes and the determined leading vehicle, the distance to the leading vehicle is determined by processing sensor data captured by the forward-sensing sensor. The data transmitted from these sensors to the ECU 16 may represent various attributes of detected objects and lane features within the operational environment of the equipped vehicle. The sensor fusion module may combine the diverse raw sensor data to create a more robust and accurate representation of the vehicle's surroundings, compensating for individual sensor limitations and enhancing overall perception reliability.

The ACC system also includes a vehicle state estimator that estimates states (i.e., speed and yaw rate) of the equipped vehicle. The state of the equipped vehicle may account for current state and external factors (e.g., road gradient). The ACC system may perform lane processing by processing raw lane data to filter out low-confidence lane markings, noise, and other disturbances to generate processed lane information. This processing generates refined lane information, which may include lane boundary positions, curvature, and lane width, enabling the system to accurately determine the vehicle's position within a traffic lane. In some examples, the ACC system performs target object selection that determines or identifies a target object or target objects that the ACC system should focus on from the surrounding objects. For example, the target object may be another vehicle traveling in the same lane as the equipped vehicle (i.e., a leading vehicle). The driver input or human machine interface (HMI) module receives various input signals from the driver and sends the signals related to turning the ACC system on or off, selecting the desired gap settings, etc. to the ACC system.

A decision making module uses vehicle states (e.g., vehicle speed, yaw rate, etc.), target object details, and driver input to determine whether to enable or disable the ACC feature. The trajectory generation module computes a predicted vehicle path or trajectory of the equipped vehicle in terms of various vehicle states (e.g., distance, velocity, and/or acceleration) for the equipped vehicle to follow. The control module uses the desired vehicle trajectory and current vehicle states to generate longitudinal acceleration commands for the vehicle to follow the intended trajectory. The powertrain module includes hardware and software which applies torque commands to achieve the commanded longitudinal acceleration thereby enabling the ADAS features for longitudinal control.

The vehicular ADAS incorporates ACC features to enhance vehicle safety and driver comfort by automatically adjusting vehicle speed and maintaining safe distance from preceding vehicles. The core function of the ACC involves dynamically controlling both vehicle velocity and distance based on user-selected gap settings.

Several gap-setting options are available for selection by the driver. Generally, gap settings are defined in terms of time. In particular, a gap setting of a specified time duration implies that the equipped vehicle will maintain a distance equivalent to the current speed multiplied by the specified time duration. For example, the specified time duration may include options between one and five seconds, such as 1.2 seconds, 1.8 seconds, 2.2 seconds, three seconds, four seconds, etc. Put another way, the gap setting of the specified time duration may define an amount of time it would take the equipped vehicle to collide with the other vehicle if the other vehicle instantly stops and the equipped vehicle continues at a current velocity. This time-based approach provides a dynamic following distance that scales with the equipped vehicle's speed, offering a consistent sense of relative spacing.

The gap settings may range from smallest to largest gaps, with intermediate options in between, such as medium gap settings. For example, a typical gap setting may include the smallest gap setting of 1.2 seconds, a medium gap setting of 1.8 seconds, and a largest gap setting of 2.2 seconds, or, for example, the smallest gap setting may be one second, the medium gap setting may be three seconds, and the largest gap setting may be five seconds. However, in other examples, gap settings may be defined in terms of distance (e.g., in feet or meters) between the equipped vehicle and other vehicles traveling within the predicted path of the equipped vehicle and in front of the equipped vehicle. A distance-based gap setting directly specifies a fixed separation distance regardless of speed. The time or distance gap setting may vary depending on the speed of the vehicle (e.g., a larger gap setting may be applied when the vehicles are traveling along a highway as compared to a smaller gap setting when the vehicles are traveling along a city road).

The ACC engages the gap-setting mode when a target vehicle travels ahead of the equipped vehicle and at a speed lower than or equal to the driver-set speed. For instance, if the driver sets a speed of 75 miles per hour (mph) and a leading vehicle (i.e., a vehicle in front the equipped vehicle and traveling in the same lane as the equipped vehicle) travels at 65 mph, the ACC system adjusts the speed of the equipped vehicle to 65 mph while maintaining a gap (e.g., specified time duration or specified distance) behind the target vehicle. In some examples, in addition to or alternative to the gap or distance being based on a user setting, the gap setting is based on one or more environmental conditions (e.g., weather, traffic, visibility levels, etc.). For example, when the vehicle is an autonomous vehicle, the system may determine an appropriate gap or distance based on the current environmental conditions. Such environmental conditions may include, but are not limited to, the presence of rain, snow, or fog, which may reduce visibility and necessitate a larger following distance. Additionally, traffic density, such as heavy congestion, may influence the system to select a smaller gap to maintain traffic flow, while open road conditions may allow for a larger, more comfortable gap. The system may also consider road surface conditions, such as wet or icy roads, to adjust the gap for enhanced safety. The ACC system continuously monitors these conditions and adjusts the target gap parameters accordingly, ensuring an optimal balance between safety, comfort, and efficiency.

The primary challenge of ACC using gap control mode is synchronizing the velocity of the equipped vehicle with that of the target vehicle and maintaining safe distances. This requires continuous adjustment between velocity and distance, where changes in speed (i.e., velocity) directly affects the gap distance, and vice versa. Therefore, two interconnected states of velocity and distance require regulation. For example, consider a scenario where an equipped vehicle travels at 75 mph and follows a leading vehicle moving at 60 mph. Initially set at the shortest gap setting, the equipped vehicle matches the 60 mph speed of the leading vehicle and maintains the shortest gap selected (e.g., by the driver or by the system). If the gap is subsequently adjusted (e.g., based on a user input or based on a change in environmental conditions) to the largest gap setting, the equipped vehicle first reduces its speed (e.g., below the 60 mph) to increase the distance from the leading vehicle to achieve the largest gap setting. Once the largest gap setting is achieved, the equipped vehicle will again match the speed of the leading vehicle (e.g., the 60 mph speed of the leading vehicle) with the new adjusted distance in place. A challenge here is determining the appropriate adjustments in velocity, such as determining whether the adjustments include decreasing velocity, increasing velocity, or maintaining velocity. Moreover, various driving scenarios, such as the leading vehicle accelerating, decelerating, or making unexpected maneuvers, further complicates the determination, thereby requiring advanced algorithms. Thus, the effectiveness of the ACC in gap control mode relies on the ability to dynamically manage vehicle velocity and distance while adapting to changing driving conditions and user preferences for a safe and comfortable driving experience.

Since two states (e.g., velocity and distance) are involved in the longitudinal control problem, traditional controllers have separate controllers for distance and velocity. These separate controllers may potentially lead to conflicts between the two controllers. For example, in the scenario above, if the distance controller aims to increase the gap by reducing velocity, the velocity controller may seek to maintain speed, thereby creating a conflict that results in vehicle oscillation. The independent operation of these control elements may produce an oscillatory or suboptimal response in certain dynamic driving situations. One approach to mitigate this issue involves rules-based controls. In this approach, the influence of the distance controller diminishes as distance requirements are met which allows the velocity controller to dominate the ACC command. However, this approach requires extensive tuning efforts tailored to specific vehicle testing. The complexity of rules-based systems may also increase with the number of driving scenarios and parameters considered, potentially leading to challenges in calibration and validation.

Implementations herein include a vehicular sensing system or a vehicular driving assist system or vehicular control system that address this issue using a controller with a single state. This can be achieved by generating a velocity profile with respect to time. The velocity profile may include a respective velocity of the equipped vehicle, a respective distance traveled by the equipped vehicle, and/or a respective acceleration of the equipped vehicle at each time step of the velocity profile. Each of these parameters (e.g., velocity, distance, and acceleration) is defined for discrete time intervals within the overall velocity profile. If the velocity profile is followed by the equipped vehicle, the velocity profile ensures that the equipped vehicle reaches the final velocity from the initial velocity while also achieving the final required time gap or distance. By adhering to the pre-calculated velocity profile, the system smoothly transitions the vehicle from the current state (e.g., initial velocity and current gap) to a desired end state (e.g., final velocity and target gap). Then, the controller only needs to work on maintaining the velocity of the equipped vehicle according to the generated velocity profile. Therefore, instead of managing two potentially conflicting control objectives (velocity and distance) independently, the system transforms the complex dual-state problem into a single-state velocity tracking problem. The control component may continuously compare the actual velocity of the equipped vehicle with the desired velocity specified by the profile at any given time and make adjustments to maintain the desired velocity.

Moreover, the velocity profile ensures a smooth transition for the equipped vehicle from its initial state to its final state. This smooth transition is in contrast to the vehicle oscillations caused by the two separate controllers discussed above. The initial state is the current velocity and the current gap setting of the equipped vehicle, while the final state is the final velocity, equivalent to the velocity of the target vehicle, and the new intended gap setting of the equipped vehicle. The inputs to the velocity profile generator may include the intended gap setting, as well as the states of the equipped vehicle and the target vehicle, such as velocity and longitudinal acceleration. This velocity profile or trajectory may be generated based on comfort level and driving behavior (e.g., based on a driver input or learned from historical driving behavior). For example, if the driver intends to aggressively reach a certain gap setting, a velocity profile that quickly reaches the final state can be generated. On the other hand, if the driver wants to slowly reach the intended gap setting, a velocity profile that slowly reaches the final state can be generated. Here, the comfort level may be specified by the driver and set acceleration and deceleration thresholds which control how quickly the equipped vehicle reaches the certain gap setting. The acceleration and deceleration thresholds may define the maximum permissible rates of change in velocity, ensuring that the maneuver is executed within comfortable limits for the vehicle's occupants.

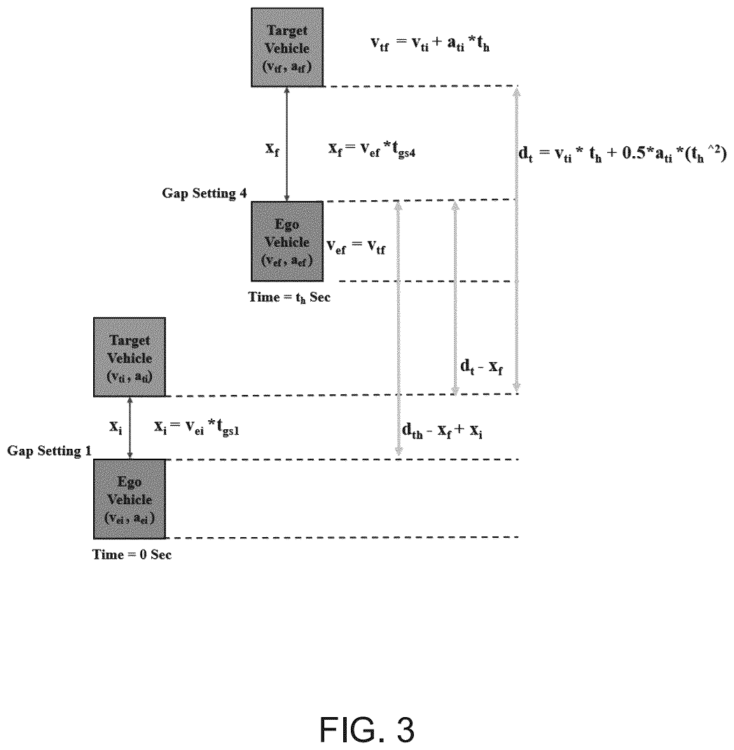

FIG. 3 illustrates an example scenario where an equipped vehicle (e.g., the “ego vehicle”) is following a target vehicle with a first time gap setting (e.g., time gap setting 1). Thereafter, the driver changes the first time gap setting to a second time gap setting (e.g., time gap setting 4). As shown in FIG. 3, at an initial time (e.g., time=0 seconds), the equipped vehicle has an initial velocity (vₑᵢ) and initial acceleration (aₑᵢ), and the target vehicle has an initial vehicle (vₜᵢ) and initial acceleration (aₜᵢ). The initial separation distance between the vehicles is denoted as xi, corresponding to gap setting 1, and may be determined as the product of the equipped vehicle's initial velocity and the time for gap setting 1 (t_{gs1}). Here, the change in the time gap setting implies a different desired following distance. In this example, it is assumed that at time (tₕ) seconds the equipped vehicle achieves the distance equivalent to the second time gap setting from the target vehicle. The diagram illustrates the state of the system at this future time, tₕ. During this time horizon tₕ, the target vehicle travels a distance dₜₕ, calculated as dₜₕ=vₜᵢ*tₕ+0.5*aₜᵢ*(tₕ), and reaches a final velocity v_{tf}, given by v_{tf}=vₜᵢ+aₜᵢ*tₕ. For the equipped vehicle to successfully match the target vehicle's speed and achieve the new gap setting, its final velocity (v_{ef}) needs to equal the target's final velocity (v_{tf}). At time tₕ, the new, final separation distance is x_{f}, corresponding to Gap Setting 4, and is calculated as x_{f}=v_{ef}*t_{gs4}. From the spatial relationships depicted in FIG. 3, the total distance the equipped vehicle must travel in time tₕ to achieve this final state is the sum of the distance traveled by the target vehicle (dtₕ) and the initial gap (xᵢ), minus the desired final gap (x_{f}), or more simply, dtₕ−x_{f}+xᵢ. This means that (tₕ) represents the duration required for the equipped vehicle to smoothly transition from maintaining the distance of the first time gap setting to maintaining the distance of the second time gap setting. Put another way, time (tₕ) represents the period of time of the velocity trajectory. Moreover, it is assumed that the target vehicle has a constant acceleration such that the initial acceleration and the final acceleration of the target vehicle will remain the same (e.g., aₜᵢ=a_{tf}). However, in some examples, the target vehicle may not have a constant acceleration.

As used herein:
vₑᵢ=initial equipped (i.e., ego) vehicle velocity
aₑᵢ=initial equipped vehicle acceleration
xᵢ=initial distance from target vehicle (e.g., represents time gap 1)
vₜᵢ=initial target vehicle velocity
aₜᵢ=initial target vehicle acceleration
t_{gs1}=time for gap setting 1
v_{ef}=final equipped vehicle velocity at tₕ seconds
a_{ef}=final equipped vehicle acceleration at tₕ seconds
x_{f}=final distance from target vehicle (e.g., represents time gap 4)
v_{tf}=final target vehicle velocity
a_{tf}=final target vehicle acceleration
t_{gs4}=time for gap setting 4
dₜ=the distance traveled by equipped vehicle after t seconds from its initial state, where 0<=t<tₕ
vₑₜ=The distance traveled by equipped vehicle after t seconds from its initial state, where 0<=t<tₕ

Thus, using the laws of motion, the velocity of the target vehicle at time (tₕ) will be:

$${v}_{tf} = {v}_{ti} + {a}_{ti} * {t}_{h} \qquad ( 1 )$$

The distance traveled by the target vehicle in (tₕ) seconds will be:

$${d}_{th} = {v}_{ti} * {t}_{h} + 0.5 * {a}_{ti} * ( {t}_{h}^{⋀ 2} ) \qquad ( 2 )$$

At time (tₕ) seconds, the velocity of the equipped vehicle will be equal or substantially equal to the velocity of the target vehicle:

$${v}_{ef} = {v}_{tf} = {v}_{ti} + {a}_{ti} * {t}_{h} \qquad ( 3 )$$

At (tₕ) seconds, the distance maintained by the equipped vehicle from the target vehicle is:

$${x}_{f} = {v}_{ef} * {t}_{gs 4} = ( {v}_{ti} + {a}_{ti} * {t}_{h} ) * {t}_{gs 4} \qquad ( 4 )$$

The initial distance maintained by the equipped vehicle from the target vehicle is:

$${x}_{i} = {v}_{ei} * {t}_{gs 1} \qquad ( 5 )$$

Hence, the total distance the equipped vehicle needs to travel in (tₕ) seconds is:

$${d}_{t h} - {x}_{f} + {x}_{i} = {v}_{ti} * {t}_{h} + 0.5 * {a}_{ti} * ( {t}_{h}^{⋀ 2} ) - ( ( {v}_{ti} + {a}_{ti} * {t}_{h} ) * {t}_{gs 4} ) + ( {v}_{ei} * {t}_{gs 1} ) \qquad ( 6 )$$

Moreover, at a time of zero seconds, the condition of the equipped vehicle is:

$$Initial velocity = {v}_{ei} \qquad ( 7 )$$

$$Initial distance = 0 \qquad ( 8 )$$

At time of (tₕ) seconds, the condition of the equipped vehicle is:

$$Final velocity = {v}_{ef} = {v}_{tf} = {v}_{ti} + {a}_{ti} * {t}_{h} \qquad ( 9 )$$

$$Final distance = {v}_{ti} * {t}_{h} + 0.5 * {a}_{ti} * ( {t}_{h}^{⋀ 2} ) - ( ( {v}_{ti} + {a}_{ti} * {t}_{h} ) * {t}_{gs 4} ) + ( {v}_{ei} * {t}_{gs 1} ) \qquad ( 10 )$$

Thus, the equipped vehicle needs to travel the following distance in (tₕ) time:

$${d}_{th} - {x}_{f} + {x}_{i} = {v}_{ti} * {t}_{h} + 0.5 * {a}_{ti} * ( {t}_{h}^{⋀ 2} ) - ( ( {v}_{ti} + {a}_{ti} * {t}_{h} ) * {t}_{gs 4} ) + ( {v}_{ei} * {t}_{gs 1} ) \qquad ( 11 )$$

Moreover, the equipped vehicle should reach the final velocity of the following from its initial velocity:

$${v}_{ti} + {a}_{ti} * {t}_{h} \qquad ( 12 )$$

A polynomial velocity trajectory may be generated to smoothly transition from the initial state to the final state without any discontinuity. A higher polynomial degree ensures smoother and more continuous transitions. Simply put, the higher polynomial degree provides more control of the equipped vehicle as the equipped vehicle transitions to the updated gap setting. Since the initial and final conditions (four conditions/states) including distances and velocities are known, the variables of a third-order polynomial can be determined. Therefore, the distance traveled by the equipped vehicle may be represented by a cubic (i.e., third-order) polynomial. Consequently, the derivative of distance, which represents velocity, may be expressed as a quadratic polynomial.

As such, at any given time t (0<=t<tₕ), the distance traveled, and velocity of the equipped vehicle may be represented as:

$${d}_{t} = A {t}^{3} + B {t}^{2} + C t + D \qquad ( 13 )$$

$${v}_{et} = 3 A {t}^{2} + 2 B t + C \qquad ( 14 )$$

Thus, to find the four unknown variables (e.g., A, B, C, D) used in Equations (13) and (14) at t=0 seconds, the following conditions are set at t=tₕ seconds:

$${d}_{t} = D = 0 \qquad ( 15 )$$

$${v}_{e t} = C = {v}_{e i} \qquad ( 16 )$$

$${d}_{t} = {At}_{h}^{3} + {Bt}_{h}^{2} + {Ct}_{h} + D = {v}_{t i} * {t}_{h} + 0.5 * {a}_{ti} * ( {t}_{h} ⋀ 2 ) - ( ( {v}_{t i +} {a}_{ti} * {t}_{h} ) * {tgs}_{4} ) + ( {v}_{ei} * {t}_{gs 1} ) \qquad ( 17 )$$

$${v}_{e t} = 3 {At}_{h}^{2} + 2 B {t}_{h} + C = {v}_{ti} + {a}_{ti} * {t}_{h} \qquad ( 18 )$$

With four variable and four equations (e.g., Equations 13-16) at hand, the four unknown variables can be solved according to:

$$D = 0 \qquad ( 19 )$$

$$C = “ vei ” \qquad ( 20 )$$

$$B = ( 1 / ( “ th ⋀ 2 ” ) ) * ( - 2 * “ vei * th ” - ( “ vti + ati * th ” ) “ * th ” + 3 * ( “ vti * th + 0.5 * ati * ( th ⋀ 2 ) - ( ( vti + ati * th ) * tgs 4 ) + ( vei * tgs 1 ) ” ) ) \qquad ( 21 )$$

$$A = ( 1 / ( “ th ⋀ 3 ” ) ) * ( “ vei * th ” + ( “ vti + ati * th ” ) “ * th ” - 2 * ( “ vti * th + 0.5 * ati * ( th ⋀ 2 ) - ( ( vti + ati * th ) * tgs 4 ) + ( vei * tgs 1 ) ” ) ) \qquad ( 22 )$$

Once the vehicle velocity trajectory is obtained to go from the current vehicle state to the final state in time (tₕ), the next step is to obtain the desired or ideal vehicle velocity. This is done by setting a look-ahead time of tₗₐ (0<=tₗₐ<tₕ) and picking the velocity value at that point. Due to overall system dynamics, there is usually some system delay between the desired velocity (v_{d}) and the actual velocity of the equipped vehicle achieved. Hence, a look-ahead time close to this delay time may be chosen to help with the compensation:

$${v}_{d} = 3 {At}_{la}^{2} + 2 {Bt}_{la} + C \qquad ( 23 )$$

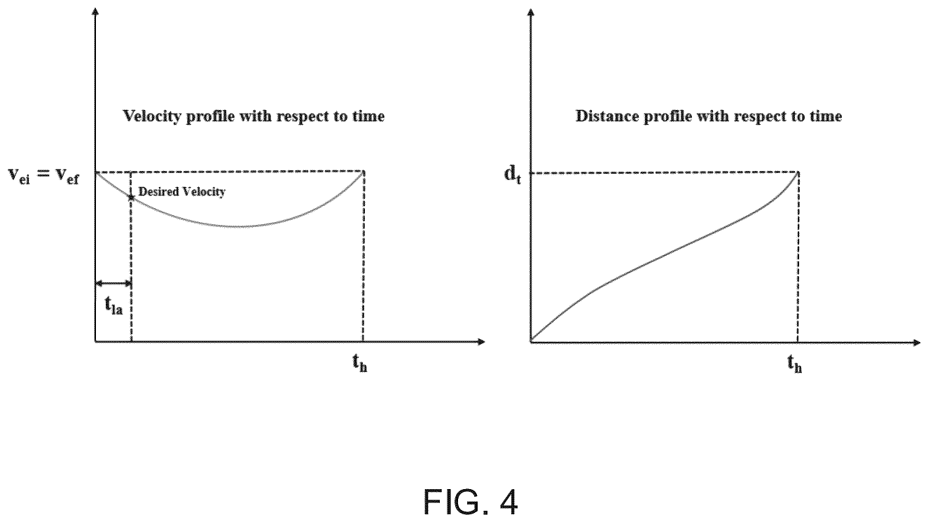

FIG. 4 illustrates the trajectory generation and the selected desired or ideal velocity. In this scenario, the equipped vehicle and the target vehicle maintain the same velocity initially with a time gap setting of 1 which is later changed to a time gap setting of 4. The two plots depict the velocity and distance trajectories over time. Since, in this example, the target vehicle maintains a constant velocity, the velocity trajectory of the equipped vehicle can be observed starting from the current velocity (vₑᵢ) of the equipped vehicle. Subsequently, the velocity decreases over time, then returns to the initial velocity (vₑᵢ) at the end of horizon time (tₕ). During the velocity reduction period, the distance from the target vehicle increases until the selected time gap is achieved. As discussed earlier, to determine the desired velocity, a lookahead time (tₗₐ) may be chosen and the velocity corresponding to that lookahead time is determined as the desired velocity, as illustrated in FIG. 4.

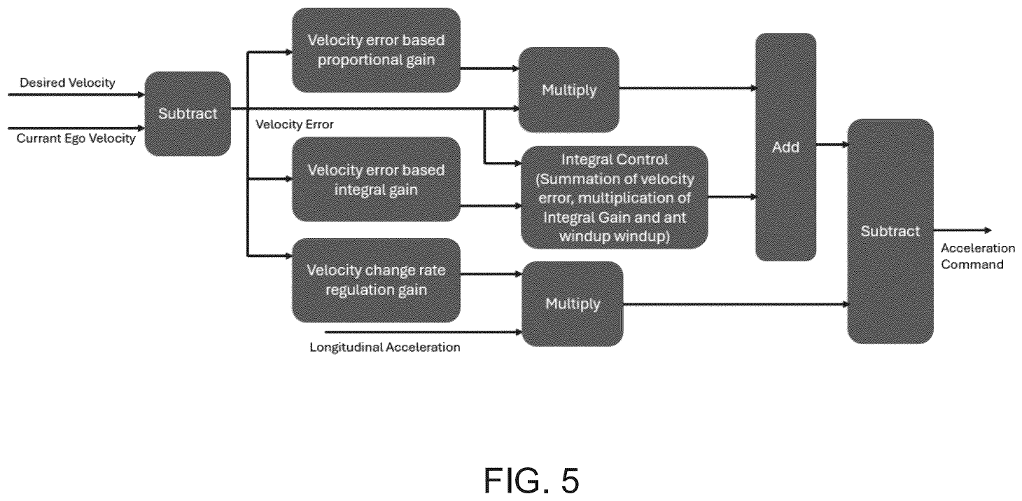

Referring now to FIG. 5, after determining the desired vehicle velocity (i.e., ideal vehicle velocity), the system may transmit the desired vehicle velocity to the controller. Here, the controller generates the necessary acceleration command to achieve the desired velocity. This capability allows the system to maintain both the desired velocity and gap effectively. By continuously adjusting the vehicle's acceleration to track the desired velocity from the trajectory, the system may precisely manage the distance to a leading vehicle while ensuring a smooth and responsive driving experience.

The control algorithm begins by determining the error between the desired and actual velocity to determine the velocity error. The control algorithm may compute the velocity error by subtracting the actual velocity (i.e., current velocity) of the equipped vehicle from the desired velocity provided by the trajectory generation module using an initial subtract block. Based on this velocity error, which is fed into a velocity error based proportional gain block and a velocity error integral gain block, proportional and integral gains may be determined. These gains are coefficients that scale the influence of the velocity error on the control output. When the velocity error is high (e.g., greater than a first threshold), both gains may be increased. An increased gain amplifies the response by the controller, allowing for a more aggressive adjustment to quickly reduce a large error. On the other hand, when the velocity error is low (i.e., lower than a second threshold), both gains may be decreased. A decreased gain reduces the responsiveness of the controller, which may help prevent oscillations and promote smoother control when the equipped vehicle is already close to the desired velocity. The first threshold and the second threshold may be the same or they may be different. This approach ensures that the controller remains less reactive at lower velocity errors but responsive to higher errors.

As illustrated in FIG. 5, the proportional gain from the velocity error based proportional gain block may be applied by multiplying the gain with the velocity error in a multiply block to obtain the proportional term. The proportional term provides an immediate control action that is directly proportional to the current velocity error. A larger error results in a larger proportional term, leading to a stronger corrective acceleration command. Similarly, the velocity error is provided to an integral control block along with the velocity error based integral gain. The integral control block determines an integral term, for example, by multiplying the velocity error by the integral gain and then summing (or integrating) the result over time. The integral term accumulates past errors over time, allowing the controller to eliminate persistent steady-state errors. The anti-windup mechanism is included to prevent the integral term from accumulating excessively when the control output saturates (e.g., when maximum braking or acceleration is commanded), which could otherwise lead to overshoot and sluggish recovery.

However, this approach does not include the derivative term due to the inherent noise in calculating the velocity error derivative. Instead of a traditional derivative term that acts on the error, a feed-forward damping term is used to help regulate speed changes and prevent overshoot. To address this, the longitudinal acceleration may be multiplied by the velocity change rate regulation gain to derive the term that regulates velocity change rates. The final acceleration command is derived by adding the proportional and integral terms in an add block. Then, in a final subtract block, the feedforward damping term is subtracted from the sum of the proportional and integral terms. This resultant command is then sent to the powertrain module. The powertrain module may subsequently translate this acceleration command into physical actions, such as adjusting engine torque or applying brakes, to achieve the desired vehicle motion.

As discussed above, conventional ACC systems control velocity and distance of the equipped vehicle thereby leading to discontinuous (i.e., oscillation) control of the equipped vehicle when the driver-selected gap changes. To address this, the vehicular ADAS system may instruct the equipped vehicle to travel at an initial velocity and at least at an initial driver-selected gap from another vehicle traveling along a same lane or road and ahead of the equipped vehicle. Subsequently, the driver of the equipped vehicle may change the driver-selected gap. That is, the driver may generate a request that includes an updated driver-selected gap different from the initial driver-selected gap. For example, the equipped vehicle may be traveling at an initial driver-selected gap of 1.2 seconds from the other vehicle ahead of the equipped vehicle, and then receive an updated driver-selected gap of 2.2 seconds. In this example, upon receiving the request, the gap between the equipped vehicle and the other vehicle is less than 2.2 seconds.

To that end, the system may determine a velocity trajectory over a period of time. Here, the period of time represents the time between receiving the request and when the distance between the equipped vehicle and the other vehicle satisfies the updated driver-selected gap. For example, the system may determine that it will take the equipped vehicle 10 seconds to reduce its velocity and satisfy the updated driver-selected gap.

The period of time may be made up of a number of discrete time steps. At each time step over the period of time, the velocity trajectory may specify or define a respective velocity, a respective distance traveled by the equipped vehicle, and/or a respective acceleration. For example, with a period of time of ten seconds, the velocity trajectory may specify at each one second interval or time step the respective velocity, the respective distance traveled, and/or the respective acceleration the equipped vehicle should travel at to achieve the updated driver-selected gap. Advantageously, by determining the velocity trajectory over the period of time, the vehicular ADAS only has one state to consider, namely, time. Here, at each time step over the period of time, the system determines velocity, distance, and acceleration of the vehicle such that at the end of the velocity trajectory the equipped vehicle is traveling at a distance that satisfies the updated driver-selected gap. Thus, the system may generate acceleration commands (e.g., torque requests and/or brake requests) that control the velocity of the equipped vehicle based on the velocity trajectory over the period of time.

The vehicular control system addresses challenges in ACC by moving beyond conventional dual-state controllers for velocity and distance. This includes generation of a comprehensive velocity profile over a specific period. This profile defines the equipped vehicle's desired speed, distance traveled, and acceleration at each discrete time step within that period. This integrated approach transforms the complex problem of regulating two interconnected states (velocity and distance) into a more streamlined single-state velocity tracking problem. By planning the entire maneuver from an initial state (current velocity and initial gap) to a desired end state (final velocity and target gap) via a single velocity profile, the system ensures a smooth and continuous transition, which may avoid the oscillatory behavior observed in systems employing separate, potentially conflicting, velocity and distance controllers. The system dynamically adjusts to changes in the desired gap, whether initiated by a driver or determined by environmental conditions, by recalculating this cohesive velocity profile. This may lead to more comfortable and efficient vehicle maneuvers.

The system may determine the velocity profile using a third-order polynomial for distance and a second-order polynomial for velocity of the equipped vehicle. The use of a third-order polynomial for distance and its derivative, a second-order polynomial for velocity may provide a balance between computational efficiency and the ability to generate smooth, continuous, and realistic vehicle motion profiles. A third-order polynomial for distance inherently ensures that both velocity (first derivative) and acceleration (second derivative) are continuous, which may reduce jerk and provide a more comfortable experience for occupants. Specifically, with initial and final conditions for both distance and velocity, four constraints are available. A third-order polynomial has four coefficients, allowing for the determination of a curve that satisfies these boundary conditions. This contrasts with lower-order polynomials that may not be able to satisfy all conditions for smooth transitions. The second-order polynomial for velocity, being the derivative of the third-order distance polynomial, naturally follows this formulation. This hierarchical polynomial structure provides mathematical consistency and physical plausibility for the generated trajectory. This polynomial approach allows the system to define a complete and pre-determined movement plan, ensuring a smooth transition from an initial state (current velocity and initial gap) to a desired end state (final velocity and target gap) without abrupt changes in velocity or acceleration, which may otherwise occur with other control strategies or rule-based systems. The system also includes a control algorithm that utilizes a desired velocity derived from a look-ahead time within the generated profile. This algorithm dynamically adjusts proportional and integral gains based on the velocity error, and incorporates a velocity change rate regulation gain, which may serve as a surrogate for a derivative term to mitigate noise and prevent overshoot. This control strategy allows for precise management of the equipped vehicle's motion to achieve and maintain the desired gap from a leading vehicle.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular control system, the vehicular control system comprising:
a sensor disposed at a vehicle equipped with the vehicular control system and sensing at least forward of the vehicle;
wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor for processing sensor data captured by the sensor and transferred to the ECU;
wherein the vehicular control system, responsive to processing at the ECU of captured sensor data, determines a leading vehicle in front of the equipped vehicle and within a traffic lane the equipped vehicle is currently traveling along;
wherein the vehicular control system, responsive to determining the leading vehicle, controls the equipped vehicle to travel at a following speed that approximates speed of the leading vehicle with at least an initial following distance between the equipped vehicle and the leading vehicle;
wherein the vehicular control system, while the equipped vehicle is traveling at the following speed with at least the initial following distance between the equipped vehicle and the leading vehicle, receives, from a driver of the equipped vehicle, an updated following distance different from the initial following distance;
wherein the vehicular control system, responsive to receiving the updated following distance from the driver of the equipped vehicle, determines a period of time based on the initial following distance, the updated following distance, and the following speed, and wherein the determined period of time represents a duration of time during which the equipped vehicle transitions from the initial following distance to the updated following distance;
wherein the vehicular control system determines a velocity profile for the equipped vehicle to follow based on the determined period of time, and wherein the velocity profile is determined such that the equipped vehicle is following the leading vehicle at the updated following distance and at the following speed at an end of the period of time; and
wherein the vehicular control system controls acceleration of the equipped vehicle based on the velocity profile to establish the updated following distance between the equipped vehicle and the leading vehicle.

2. The vehicular control system of claim 1, wherein the initial following distance corresponds to a current speed of the equipped vehicle multiplied by a predetermined time duration.

3. The vehicular control system of claim 1, wherein the initial following distance is greater than the updated following distance.

4. The vehicular control system of claim 1, wherein the initial following distance is less than the updated following distance.

5. The vehicular control system of claim 1, wherein the velocity profile comprises a plurality of time steps, and wherein, at each time step of the plurality of time steps, the velocity profile defines at least one selected from the group consisting of (i) a respective speed of the equipped vehicle, (ii) a respective distance traveled by the equipped vehicle and (iii) a respective acceleration of the equipped vehicle.

6. The vehicular control system of claim 5, wherein the vehicular control system controls the acceleration of the equipped vehicle by, for each time step of the plurality of time steps, (i) determining a target speed of the equipped vehicle based on the velocity profile and (ii) controlling the acceleration of the equipped vehicle based on the determined target speed.

7. The vehicular control system of claim 6, wherein the vehicular control system determines the target speed based on a look-ahead value.

8. The vehicular control system of claim 6, wherein the vehicular control system controls the acceleration of the equipped vehicle based on determining a gain based on a comparison of the target speed with an actual speed of the equipped vehicle and controlling the acceleration of the equipped vehicle based on the determined gain.

9. The vehicular control system of claim 8, wherein the vehicular control system, responsive to determining that an error between the target speed and the actual speed exceeds a threshold, increases the determined gain.

10. The vehicular control system of claim 8, wherein the vehicular control system, responsive to determining that an error between the target speed and the actual speed fails to exceed a threshold, decreases the determined gain.

11. The vehicular control system of claim 1, wherein the sensor comprises a forward-viewing camera.

12. The vehicular control system of claim 1, wherein the sensor comprises a forward-sensing radar sensor.

13. The vehicular control system of claim 1, wherein the sensor comprises a forward-sensing lidar sensor.

14. The vehicular control system of claim 1, wherein the sensor comprises a forward-sensing ultrasonic sensor.

15. The vehicular control system of claim 1, wherein the velocity profile is based on a driver configurable in-vehicle comfort metric.

16. The vehicular control system of claim 1, wherein speed of the equipped vehicle over the period of time is represented by a second-order polynomial, and wherein distance traveled by the equipped vehicle over the period of time is represented by a third-order polynomial.

17. The vehicular control system of claim 1, wherein the vehicular control system, after establishing the updated following distance between the equipped vehicle and the leading vehicle, controls the equipped vehicle to travel at an updated speed.

18. The vehicular control system of claim 17, wherein the following speed is equal to the updated speed.

19. The vehicular control system of claim 1, wherein the sensor comprises a forward-viewing camera disposed at an in-cabin side of a windshield, the forward-viewing camera viewing forward of the vehicle through the windshield.

20. The vehicular control system of claim 19, wherein the vehicular control system, responsive to processing at the ECU of sensor data captured by the forward-viewing camera, determines lane markers of at least the traffic lane the equipped vehicle is currently traveling along.

21. The vehicular control system of claim 20, wherein the sensor comprises a plurality of sensors, and wherein the plurality of sensors further comprises at least one non-imaging sensor selected from the group consisting of (i) a forward-sensing radar sensor, (ii) a forward-sensing lidar sensor and (iii) a forward-sensing ultrasonic sensor, and wherein the initial following distance and the updated following distance between the equipped vehicle and the leading vehicle is determined by processing sensor data captured by the at least one non-imaging sensor.

22. A vehicular control system, the vehicular control system comprising:
a sensor disposed at a vehicle equipped with the vehicular control system and sensing at least forward of the vehicle;
wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor for processing sensor data captured by the sensor and transferred to the ECU;
wherein the vehicular control system, responsive to processing at the ECU of captured sensor data, determines a leading vehicle in front of the equipped vehicle and within a traffic lane the equipped vehicle is currently traveling along;
wherein the vehicular control system, responsive to determining the leading vehicle, controls the equipped vehicle to travel at a following speed that approximates speed of the leading vehicle with at least an initial following distance between the equipped vehicle and the leading vehicle;
wherein the vehicular control system, while the equipped vehicle is traveling at the following speed with at least the initial following distance between the equipped vehicle and the leading vehicle, receives, from a driver of the equipped vehicle, an updated following distance that is greater than the initial following distance;
wherein the vehicular control system, responsive to receiving the updated following distance from the driver of the equipped vehicle, determines a period of time based on the initial following distance, the updated following distance, and the following speed, and wherein the determined period of time represents a duration of time during which the equipped vehicle transitions from the initial following distance to the updated following distance, and wherein speed of the equipped vehicle over the period of time is represented by a second-order polynomial, and wherein distance traveled by the equipped vehicle over the period of time is represented by a third-order polynomial;
wherein the vehicular control system determines a velocity profile for the equipped vehicle to follow based on the determined period of time, and wherein the velocity profile is determined such that the equipped vehicle is following the leading vehicle at the updated following distance and at the following speed at an end of the period of time; and
wherein the vehicular control system controls acceleration of the equipped vehicle based on the velocity profile to establish the updated following distance between the equipped vehicle and the leading vehicle.

23. The vehicular control system of claim 22, wherein the velocity profile comprises a plurality of time steps, and wherein, at each time step of the plurality of time steps, the velocity profile defines at least one selected from the group consisting of (i) a respective speed of the equipped vehicle, (ii) a respective distance traveled by the equipped vehicle and (iii) a respective acceleration of the equipped vehicle.

24. The vehicular control system of claim 23, wherein the vehicular control system controls the acceleration of the equipped vehicle by, for each time step of the plurality of time steps, (i) determining a target speed of the equipped vehicle based on the velocity profile and (ii) controlling the acceleration of the equipped vehicle based on the determined target speed.

25. A vehicular control system, the vehicular control system comprising:
a sensor disposed at a vehicle equipped with the vehicular control system and sensing at least forward of the vehicle;
wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises a data processor for processing sensor data captured by the sensor and transferred to the ECU;
wherein the vehicular control system, responsive to processing at the ECU of captured sensor data, determines a leading vehicle in front of the equipped vehicle and within a traffic lane the equipped vehicle is currently traveling along;
wherein the vehicular control system, responsive to determining the leading vehicle, controls the equipped vehicle to travel at a following speed that approximates speed of the leading vehicle with at least an initial following distance between the equipped vehicle and the leading vehicle;
wherein the vehicular control system, while the equipped vehicle is traveling at the following speed with at least the initial following distance between the equipped vehicle and the leading vehicle, receives, from a driver of the equipped vehicle, an updated following distance that is less than the initial following distance;
wherein the vehicular control system, responsive to receiving the updated following distance from the driver of the equipped vehicle, determines a period of time based on the initial following distance, the updated following distance, and the following speed, and wherein the determined period of time represents a duration of time during which the equipped vehicle transitions from the initial following distance to the updated following distance;
wherein the vehicular control system determines a velocity profile for the equipped vehicle to follow based on the determined period of time, and wherein the velocity profile is determined such that the equipped vehicle is following the leading vehicle at the updated following distance and at the following speed at an end of the period of time, and wherein the velocity profile comprises a plurality of time steps, and wherein, at each time step of the plurality of time steps, the velocity profile defines at least one selected from the group consisting of (i) a respective speed of the equipped vehicle, (ii) a respective distance traveled by the equipped vehicle and (iii) a respective acceleration of the equipped vehicle; and
wherein the vehicular control system controls acceleration of the equipped vehicle based on the velocity profile to establish the updated following distance between the equipped vehicle and the leading vehicle.

26. The vehicular control system of claim 25, wherein speed of the equipped vehicle over the period of time is represented by a second-order polynomial, and wherein distance traveled by the equipped vehicle over the period of time is represented by a third-order polynomial.

27. The vehicular control system of claim 26, wherein the vehicular control system controls the acceleration of the equipped vehicle by, for each time step of the plurality of time steps, (i) determining a target speed of the equipped vehicle based on the velocity profile and (ii) controlling the acceleration of the equipped vehicle based on the determined target speed.
